(19) United States
(12) Patent Application Publication
(10) Pub. No.: US 2015/0075128 A1
(43) Pub. Date: Mar. 19, 2015

(54) Air Filter Device for a Motor Vehicle and Filter Element for an Air Filter Device

(71) Applicant: MANN+HUMMEL GMBH, Ludwigsburg (DE)

(72) Inventors: Daniel Schmid, Sachsenheim (DE); Guenter Goerg, Moeglingen (DE); Timo Dirnberger, Marbach (DE); Ralf Dietz, Remseck (DE)

(21) Appl. No.: 14/490,987

(22) Filed: Sep. 19, 2014

(30) Foreign Application Priority Data
Sep. 19, 2013 (DE) 10 2013 015 493.6

(51) Int. Cl. F02M 35/024

(52) U.S. Cl. CPC F02M 35/02416
USPC 55/502

(57) ABSTRACT

An air filter device for a motor vehicle features a filter element accommodated in a filter housing which is at least sectionwise enclosed by a surrounding frame part which is glued to the filter element. Between the frame part and the filter element is disposed a sealing lip which defines an adhesive receiving space between frame part and filter element.

### CROSS-REFERENCE TO RELATED APPLICATION

This application claims the benefit of German patent application No. 10 2013 015 493.6 filed Sep. 19, 2013, the entire contents of the aforesaid German patent application being incorporated herein by reference.

### TECHNICAL FIELD

The invention relates to an air filter device for a motor vehicle according to the preamble of claim 1 and to a filter element for such an air filter device.

### BACKGROUND

DE 10 2009 060 214 A1 describes an air filter device for the internal combustion engine of a motor vehicle. The air filter device comprises a filter element, which is inserted into a filter housing. The filter element consists of a folded filter medium and comprises a circumferential supporting frame on the outer side thereof, which is a carrier of a sealing element, which, in an installed state, fits on the inner wall of the filter housing.

The supporting frame is glued to the filter element. The adhesive connection is made between a bent leg of the supporting frame and a side wall directly adjacent to the outer side of the filter element, wherein, because of the angular position of the leg on the supporting frame, a triangular adhesive groove is formed to receive the adhesive. The angularly projecting leg of the supporting frames is designed to be one piece with a contact leg, which fits directly on the side band of the filter element.

When producing the adhesive connection between the supporting frame and filter element, the adhesive is normally filled into the adhesive groove in a non-hardened, liquid state. In this case, care must be taken to make sure that no adhesive inadvertently flows downward into the gap between the contact leg of the supporting frame and the outer side of the filter element or the side band.

### SUMMARY OF THE INVENTION

The object of the invention is to create a tight and permanent connection between an air filter element and a surrounding frame part in an air filter device using simple design measures.

The air filter device according to the invention can be used in motor vehicles, for example for filtration of the combustion air being fed to the internal combustion engine. An application in commercial vehicles as well as in passenger vehicles is possible. The air filter device comprises a filter housing and a filter element that can be inserted into the filter housing, which is enclosed partially or completely by a surrounding frame part. The frame part can be situated at a front side of the filter element, preferably on the intake front side.

The frame part is connected to the filter element through adhesion. To produce the adhesive connection in an improved and facilitated manner, when liquid adhesive is normally used, a sealing lip is disposed between the frame part and the filter element, which delimits an adhesive receiving space between the frame part and filter element. The sealing lip abuts, in particular with its free front side, the lateral surface of the filter element and thereby prevents an undesired discharge of liquid adhesive along the outer side of the filter element.

The connection between the supporting frame or the frame part and the filter element is accomplished in such a way that the frame part is slid onto the filter element until the desired axial position is reached, in which position the frame part is supposed to be adhered to the filter element. The sealing lip abuts the lateral surface of the filter element and hereby delimits the adhesive receiving space, which can be designed as a circumferential adhesive receiving groove. Then the adhesive is filled into the adhesive receiving space in a liquid, non-hardened state and is able to harden there. The sealing lip prevents the adhesive that has not hardened yet from undesirably dripping or flowing out of the adhesive receiving space.

The sealing lip can also remain on the frame part or the filter element after the adhesive has hardened and is inserted into the filter housing together with the filter element and frame part. However, it is also possible to remove the sealing lip after the adhesive connection has been completed.

The filter element is configured for example to be a rectangular solid and correspondingly comprises a rectangular cross section. The frame part surrounds the filter element preferably completely and, with a rectangular cross section of the filter element, likewise has a rectangular shape.

In the case of a polygonal design of the frame part or the filter element, it can suffice for a sealing lip to be provided only on a portion of the lateral surfaces. For example, in the case of rectangular design, a sealing lip is disposed only on two opposing sides, whereas the two other sides are designed without a sealing lip; on these sides, the filter element can be provided with a side band, on which the frame part fits. The side band can likewise delimit the adhesive receiving space, for example in that the front side of the side band rests on a step of the frame part. As a result, a delimitation of the adhesive receiving space is achieved on all sides even in the case of a circumferential design of the adhesive receiving space and only one sealing lip on a portion of the sides.

The sealing lip is firmly connected to the frame part according to a further expedient embodiment. The free front side of the sealing lip abuts the outer side of the filter element. However, a reverse design is also possible, in which the sealing lip is connected to the filter element and abuts the frame part.

The adhesive receiving space between the frame part and the filter element comprises, according to another expedient embodiment, a triangular cross section or a trapezoidal cross section and tapers towards one side, on which the sealing lip is advantageously disposed. The wider side is on the top during the production process and the adhesive can be filled in via this wider side.

According to a further expedient embodiment, the frame part is held in a flow-tight manner on the filter housing in order to prevent incorrect airflows. The flow-tight connection is accomplished via a sealing element, which is advantageously configured in a circumferential manner and lies in the frame part in a circumferential receiving space that is designed to be open. In an inserted state, the sealing element abuts the filter housing wall.

A housing-side supporting bead can be assigned to the sealing element, which projects over the directly adjacent sections of the filter housing wall and on which the sealing element is supported. The supporting bead advantageously has a smaller width than the frame-side sealing element, so that, in a mounted state, the supporting bead lies at a lateral distance from the frame part walls. This reduces the risk of the sealing element shearing off in the case of a relative movement between the filter element or the frame part and filter housing. In addition, it also prevents a portion of the projecting sealing element from being able to get jammed between the filter housing and the frame part, which would lead to a destruction of the sealing element as well as a reduction in the sealing effect.

According to yet another expediently embodiment, the circumferential frame part forms a receptacle for an air duct, which is a part of the flow path through the air filter device. The frame part receives the air duct and connects it to the filter element. The air duct is preferably used for supplying raw air to the raw side or intake side of the filter element; however, an arrangement of the air duct on the inlet or discharge side of the filter element and correspondingly a design as a clean air duct is also possible.

According to a further expedient embodiment, the frame part is disposed in a mounted state at least partially on the outer side of the filter housing. This makes it possible for the air duct to be connected directly to the frame part. In addition, the outer section of the frame part can also be used for a connection to the filter housing. Thus, the frame part has a dual function: firstly, connecting the filter element to the filter housing and, secondly, connecting the air duct to the filter element. An additional fastening device for fastening the air duct to the filter housing is not required.

### BRIEF DESCRIPTION OF THE DRAWINGS

Other advantages and expedient embodiments can be found in the other claims, the description of the figures and the drawings, which show:

FIG. 1 a perspective view of an air filter device for a motor vehicle having a filter housing and a filter element inserted on the front side, which is enclosed by a circumferential frame part via which the filter element is held on the filter housing,

FIG. 2 a rectangular filter element with a frame part on the front side,

FIG. 3 a representation corresponding to FIG. 1, however, with an air duct inserted into the frame part of the filter element,

FIG. 4 a longitudinal section through the air filter device according FIG. 3,

FIG. 5 a front view of the air filter device in the region of the intake side of the filter element,

FIG. 6 a vertical section through the air filter device,

FIG. 7 an enlarged representation of Detail VII from FIG. 4 with a sealing element on the frame part, to which a housing-side supporting bead is assigned, and with a sealing lip, which delimits an adhesive receiving space between the frame part and filter element,

FIG. 8 an enlarged representation of Detail VIII from FIG. 6 with the frame-side sealing element and the housing-side supporting bead,

FIG. 9 detail IX from FIG. 3 with a tensioning clamp for securing the frame part on the filter housing,

FIG. 10 detail X from FIG. 3 with a representation of the positive connection of the air duct on the frame part.

The same components are provided with the same reference symbols in the figures.

### DETAILED DESCRIPTION

The figures depict an air filter device 1 for a motor vehicle, for example for a commercial vehicle, which is used to filter the combustion air being fed to the internal combustion engine. The air filter device 1 comprises a filter element 3 in a filter housing 2, which is enclosed in the region of the front-side intake side thereof by a circumferential frame part 4. The filter element 3 is designed for example as a pleated filter bellows.

The frame part 4 is situated directly adjacent to the intake or raw side 5 of the filter element 3, to which the air to be cleaned is supplied in accordance with arrow 6. After filtration, the cleaned air exits via the clean side or discharge side of the filter element and leaves the filter housing 2 via a discharge port 9 in accordance with arrow 7. The filter element 3 is secured on the filter housing 2 via tensioning clamps 8, which connect the frame part 4 to the filter housing 2. In a mounted state, the frame part 4 overlaps the front edge of the filter housing and extends up the outer lateral surface of the filter housing in the region adjoining the insertion opening for the filter element.

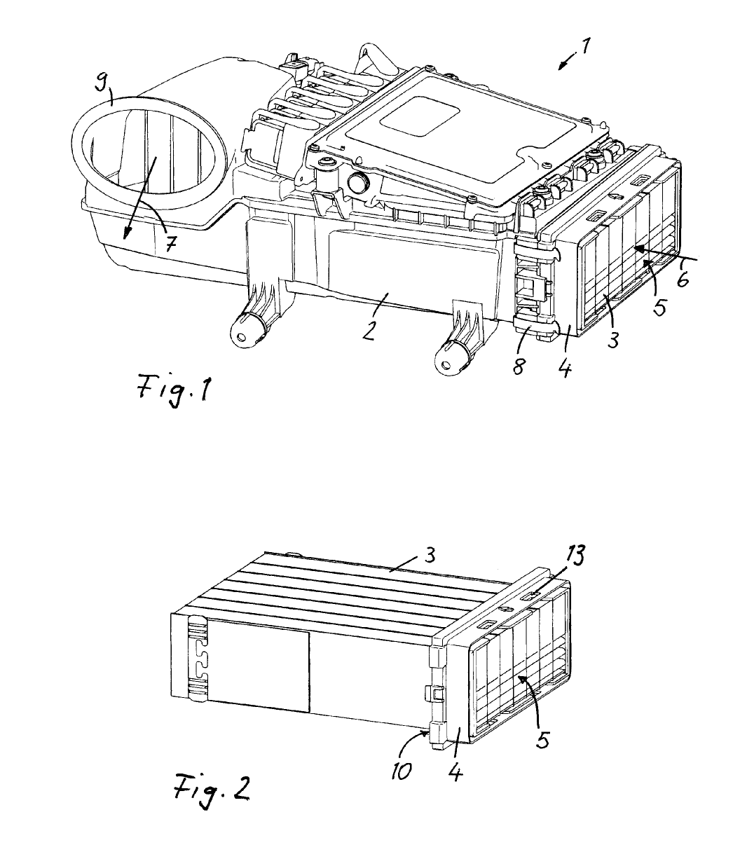

As the individual representation in FIG. 2 shows, the filter element 3 is configured to be a rectangular solid and has a rectangular cross section. Correspondingly, the intake side 5 of the filter element 3 and the frame part 4 are also configured to be rectangular. The frame part 4 projects over the outer sides of the filter element 3, wherein the front side of the frame part forms a support surface on the projecting section on the side facing away from the intake side 5, which in a mounted state rests on the open front side of the filter housing. This support surface on the frame part 4 is identified by reference symbol 10.

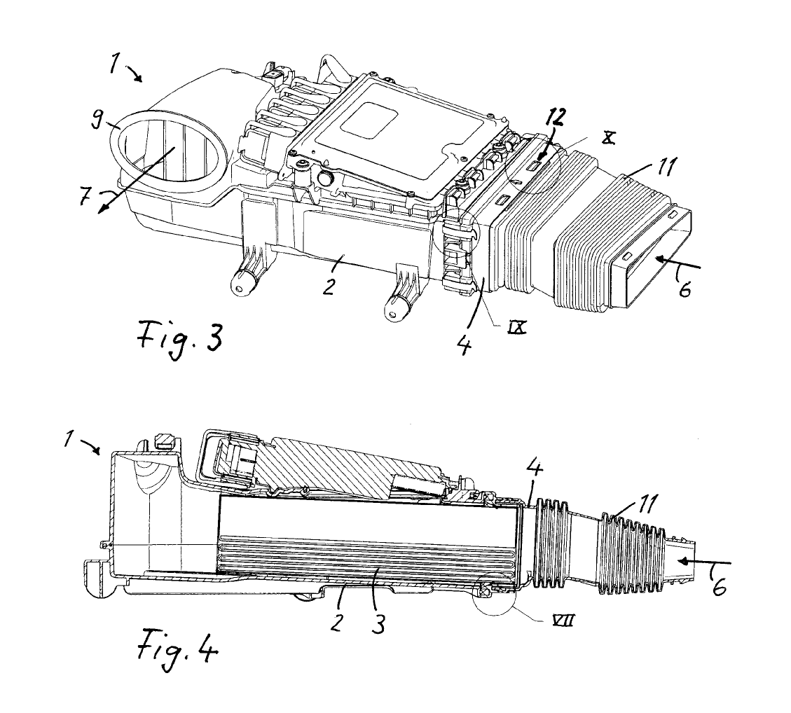

In a mounted state, the frame part 4 lies at least substantially outside of the filter housing 2 (FIGS. 1, 3 and 4) and is connected to the filter housing 2 via the tensioning clamps 8. The frame part 4 forms a receptacle for an air duct 11 in the region of the intake side of the filter element 3 (FIGS. 3 and 4), via which raw air is supplied to the air filter device 1 in accordance with the arrow 6. The air duct 11 is inserted into the receptacle in the frame part 4 and positively connected to the frame part 4 by means of a positive connection 12. The positive connection 12, which is depicted in detail in FIG. 10, has recesses 13 in the frame part 4 along with elastically resilient latches 14 on the outer side of the air duct 11 that faces the front side. The latches 14 can be pushed inwardly elastically in the radial direction so that an insertion of the air duct 11 until positive engagement of the latches 14 in the recesses 13 is possible. In the same manner, the positive connection 12 can be released again by pressing the latches 14 radially out of the recesses 13. The connection between the air duct 11 and frame part 4 is accomplished exclusively via the positive connection 12 and therefore between these two components. A connection between the air duct 11 and the filter housing 2 is not planned on the other hand. The positive connection 12 is directly outside the front-side opening in the filter housing 2.

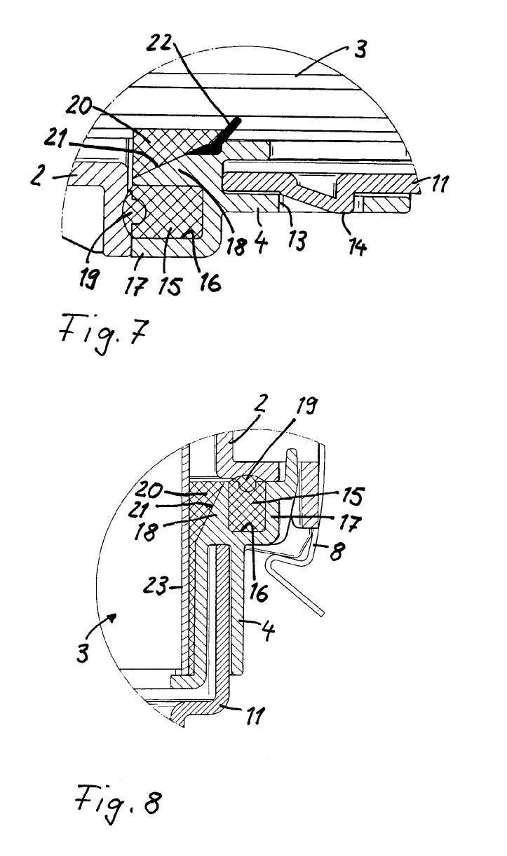

FIGS. 7 and 8 show a sealing arrangement between the frame part 4 and the filter housing 2. The sealing arrangement comprises a sealing element 15, which is inserted into a circumferential receiving space 16 on the frame part 4. The receiving space 16 is configured to be open on the front side facing the filter housing 2 and is delimited by two legs 17 and 18 that are spaced apart from each other, which are configured as one piece with the frame part 16.

A supporting bead 19, which interacts with the sealing element 15, is situated on the filter housing 2. The supporting bead 19 can be designed as one piece with the filter housing 2 or as a separately executed component, which can consist of a different material than the filter housing, but be firmly connected to the filter housing 2. The supporting bead 19 has a mushroom shape in cross section, wherein a narrower stem of the supporting bead 19 is facing the sealing element 15 and is in contact therewith. The leg of the supporting bead 19 has a smaller width than the sealing element 15 and acts on the sealing element 15 in the center. This design is sufficiently flow-tight, and also considerably reduces the risk of a shear-off in the region of the sealing element 15. The sealing element 15 advantageously concludes with the front side of the legs 17, 18 so that no shear-off can occur in the region of the front side of the sealing element 15 even in the case of relative movement between the frame part 4 and the filter housing 2.

The supporting bead 19 projects over the directly adjacent walls of the filter housing 2 and presses into the yielding material of the sealing element 15. The front side of the stem of the supporting bead 19, which protrudes into the sealing element 15, is designed to be rounded off.

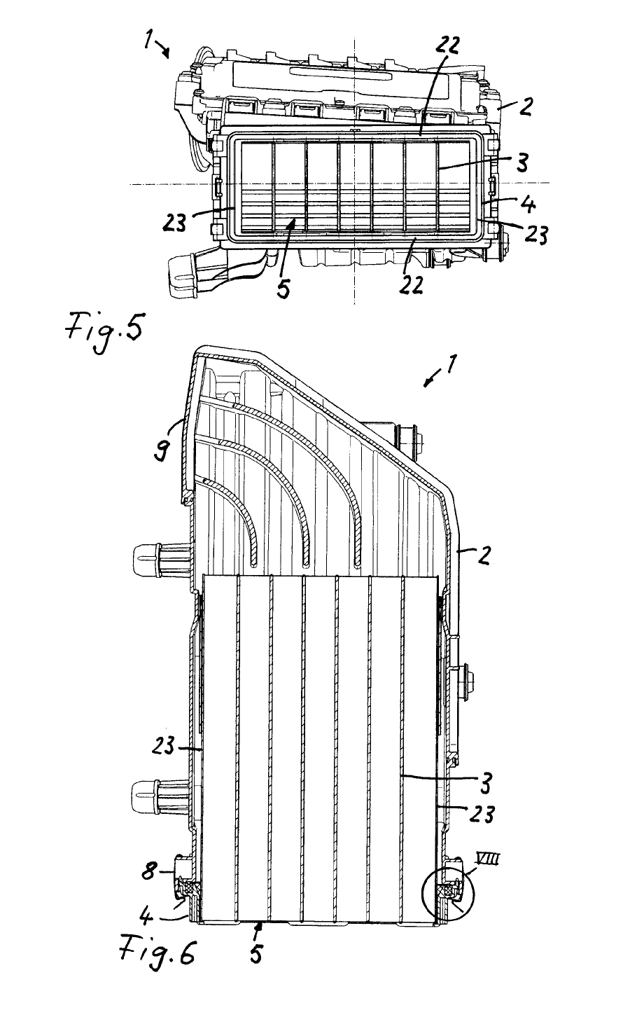

In addition, FIGS. 7 and 8 in conjunction with FIGS. 5 and 6 show that the frame part 4 is adhered to the filter element 3. The adhesion is accomplished via a circumferentially disposed adhesive input 20, which is filled into an adhesive receiving space 21 between the frame part 4 and the filter element 3. The filling takes place during the production process in a liquid adhesive state, which hardens subsequently. In order to prevent adhesive from flowing downward out of the adhesive receiving space 21 during the hardening process, a sealing lip 22 is disposed on the adhesive receiving space 21 that is approximately triangular in cross section (FIGS. 5 and 7). The sealing lip 22 is firmly connected to the frame part 4 and remains disposed on the frame part 4 even in a hardened state of the adhesive 20.

The adhesive receiving space 21 is disposed in a radially inwardly offset manner with respect to the receiving space 16 to receive the sealing element 15, and separated from the leg 18 with respect to the receiving space 16 for the sealing element 15, which leg at the same time laterally delimits the adhesive receiving space 21. Disposed on the base of the leg 18 is the sealing lip 22, which extends obliquely inwardly and delimits the tapering side of the adhesive receiving space; the free front side of the sealing lip 22 abuts the outer lateral surface of the filter element 3.

The sealing lip 22 is disposed on the two opposing longitudinal sides of the rectangular frame part 4 (FIG. 5). Situated on each narrow side of the filter element 3 is a side band 23, which is firmly connected to the filter element 3 and which, in the region of the narrow sides, delimits the adhesive receiving space 21 towards the tapering sides thereof (FIGS. 5, 6 and 8).

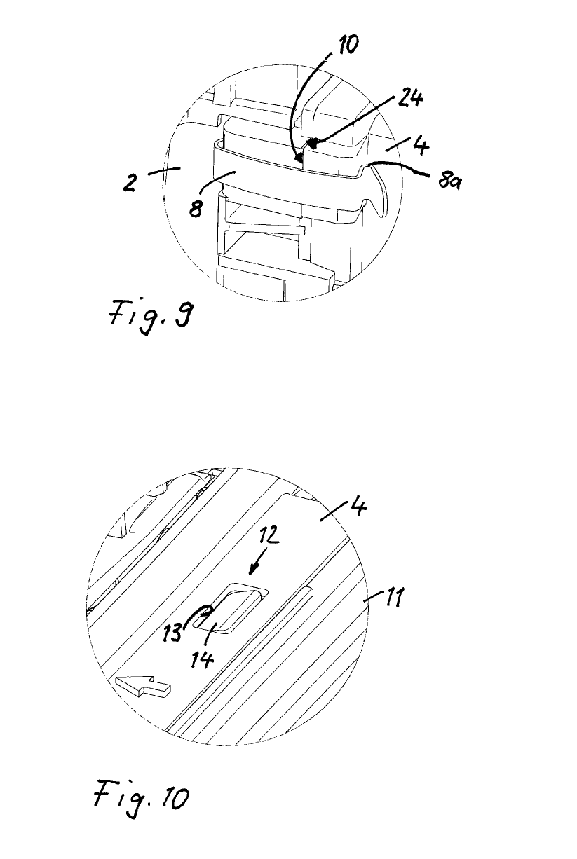

FIG. 9 depicts the support of the frame part 4 on a counter contact surface on the filter housing 2 along with the connection via the tensioning clamp 8. The portion of the frame part 4 projecting radially over the filter element comprises the support surface 10 (also see FIG. 2), which faces away from the intake side and in a connected state abuts the counter contact surface 24 on the filter housing. The tensioning clamp 8 is held so that it can make a swiveling movement on the outer surface of the filter housing 2 and, in a tensioned state, overlaps both the housing-side section with the counter contact surface 24 along with the section of the frame part 4 with the support surface 10. The tensioning clamp 8 is designed to be elastic; in a tensioned state, a tension section 8a overlaps 8a the step on the frame part 4, on which the support surface 10 is disposed, and hereby presses the frame part 4 with the support surface 10 against the counter contact surface 24 on the filter housing 2.

We claim:

1. An air filter device for a motor vehicle, comprising:
a filter housing (3);
an filter element (3) arranged within the filter housing (2);
a frame part (4) circumferentially surround the filter element and at least sectionwise enclosing the filter element;
wherein the frame part (4) is secured to the filter element (3) by an adhesive;
a sealing lip disposed between the frame part (4) and the filter element (3), the sealing lip defining an adhesive receiving space (21) between the frame part (4) and the filter element (3).

2. The air filter device according to claim 1, wherein
the frame part (4) and the filter element (3) are rectangular and a sealing lip (22) is respectively disposed on only two opposing sides.

3. The air filter device according to claim 2, wherein
a projecting side band (23) is applied onto the filter element (3) on each adjacent side, which rests on the frame part (4).

4. The air filter device according to claim 1, wherein
the adhesive receiving space (21) between the frame part (4) and filter element (3) comprises a triangular cross section;
wherein the sealing lip (22) is disposed in a tapered corner region.

5. The air filter device according to claim 1, wherein
the sealing lip (22) is firmly secured onto the frame part (4).

6. The air filter device according to claim 1, wherein
a separate sealing element (15), which fits on the filter housing (2), is disposed on the frame part (4).

7. The air filter device according to claim 6, wherein
a supporting bead (19) is held on the filter housing (2), which projects over the directly adjacent filter housing wall, and supports the frame-side sealing element (15) on the housing-side supporting bead (19).

8. The air filter device according to claim 6, wherein
the sealing lip (22) is disposed in an offset manner parallel to the sealing element (15) on the frame part (4).

9. The air filter device according to claim 1, wherein
the surrounding frame part (4) forms a receptacle for an air duct (11) on the filter element (3);
wherein the frame part (4) is disposed at least partially on the outer side of the filter housing (2).

10. The air filter device according to claim 1, wherein
an air duct (11) is received into the frame part (4) and the frame part (4) is held via its outer side on the filter housing (2).

11. A filter element (3) for an air filter device according to claim 1.
